(19) United States
(12) Patent Application Publication
(10) Pub. No.: US 2026/0229547 A1
(43) Pub. Date: Aug. 6, 2026

(54) CURRENT COLLECTOR FOR BIPOLAR ELECTRODE

(71) Applicant: TOYOTA JIDOSHA KABUSHIKI KAISHA, Toyota-shi (JP)

(72) Inventors: Yusuke KINTSU, Miyoshi-shi (JP); Hirokazu TAKEUCHI, Toyota-shi (JP); Satoru CHIMURA, Toyota-shi (JP); Tekahiko NAKANO, Nagoya-shi (JP)

(73) Assignee: TOYOTA JIDOSHA KABUSHIKI KAISHA, Toyota-shi (JP)

(21) Appl. No.: 19/424,741

(22) Filed: Dec. 18, 2025

(30) Foreign Application Priority Data
Feb. 3, 2025 (JP) 2025-015922

(51) Int. Cl. H01M 4/66; H01M 4/02

(52) U.S. Cl. CPC H01M 4/667; H01M 4/661; H01M 2004/029

(57) ABSTRACT

A current collector for a bipolar electrode includes: an Al foil provided on one surface; and a Cu foil provided on the other surface and joined to the Al foil. A relationship between an area S1 of the Al foil and an area S2 of the Cu foil is S1 > S2. The Al foil protrudes from an end of the Cu foil.

### CROSS-REFERENCE TO RELATED APPLICATION

This application claims priority to Japanese Patent Application No. 2025-015922 filed on February 3, 2025. The disclosure of the above-identified application, including the specification, drawings, and claims, is incorporated by reference herein in its entirety.

### BACKGROUND

### Technical Field

The present disclosure relates to a current collector for a bipolar electrode.

### Description of Related Art

Japanese Unexamined Patent Application Publication No. 2022-075283 (JP 2022-075283 A) discloses a current collector for a bipolar electrode that uses an Al foil on a cathode side and a Cu foil on an anode side.

### SUMMARY

The current collector in which the Al foil and the Cu foil are laminated together as disclosed in JP 2022-075283 A requires cutting of ends to obtain a specified size after the foils are formed. When the ends of the Al foil and the Cu foil are cut simultaneously, however, foreign matter composed of Cu (hereinafter referred to as "Cu foreign matter") may adhere to the Al foil. When the Cu foreign matter adheres to the Al foil, Cu elution may lead to Li deposition, which may cause self-discharge failure.

The present disclosure has been made in view of the above, and has an object to provide a current collector for a bipolar electrode that can suppress generation of Cu foreign matter during cutting.

A current collector for a bipolar electrode according to the present disclosure includes: an Al foil provided on one surface; and a Cu foil provided on the other surface and joined to the Al foil. A relationship between an area S1 of the Al foil and an area S2 of the Cu foil is S1 > S2. The Al foil protrudes from an end of the Cu foil.

According to the present disclosure, when cutting the current collector to a specified size, only the Al foil protruding from the end of the Cu foil can be cut without cutting the Cu foil. Thus, it is possible to suppress the generation of the Cu foreign matter.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing the configuration of a current collector for a bipolar electrode according to an embodiment, in which part (a) is a sectional view and part (b) is a plan view;

FIG. 2 is a plan view showing an example of a sealing member provided on a protruding portion of an Al foil in the current collector for the bipolar electrode according to the embodiment; and

FIG. 3 is a diagram showing the configuration of a current collector for a bipolar electrode according to related art, in which part (a) is a sectional view and part (b) is a plan view.

### DETAILED DESCRIPTION OF EMBODIMENTS

A current collector for a bipolar electrode according to an embodiment of the present disclosure will be described with reference to the drawings. Components in the following embodiment include components that are replaceable and easy for persons skilled in the art or components that are substantially identical.

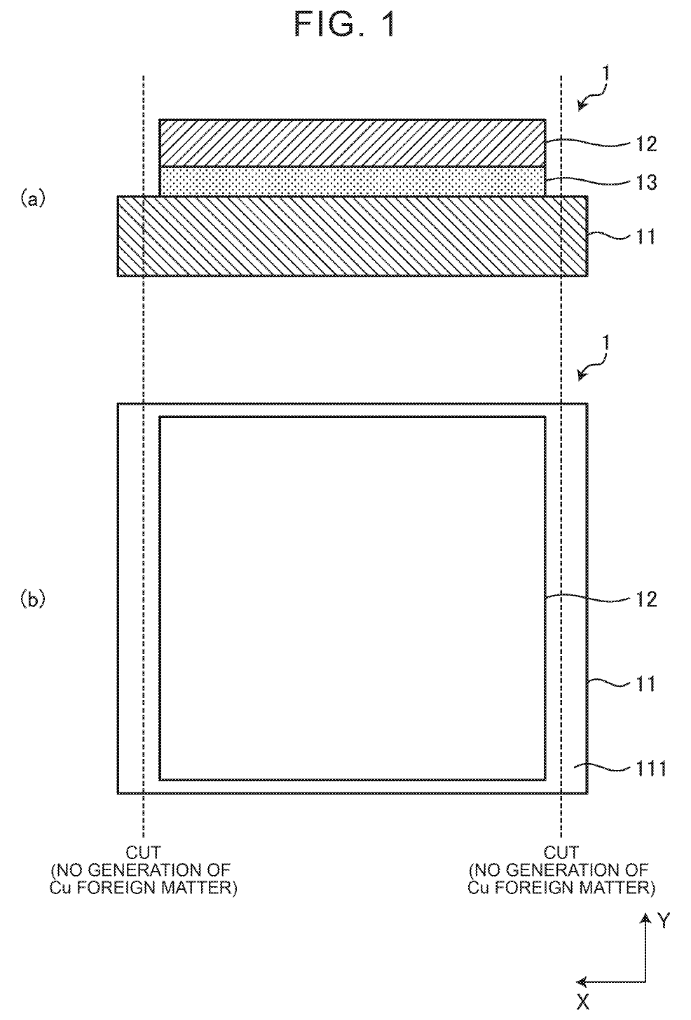

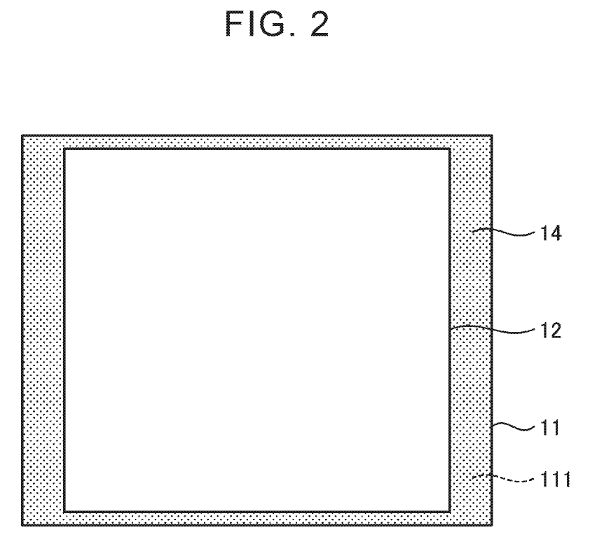

The current collector for the bipolar electrode according to the embodiment will be described with reference to FIGS. 1 and 2. The current collector for the bipolar electrode according to the embodiment is, for example, a component that constitutes a power storage module to be mounted on a vehicle. Examples of the vehicle on which the power storage module is to be mounted include hybrid electric vehicles (HEVs), plug-in hybrid electric vehicles (PHEVs), and battery electric vehicles (BEVs).

FIG. 1 is a diagram showing the configuration of a current collector 1 for a bipolar electrode according to the embodiment, in which part (a) is a sectional view of the current collector 1 as seen from the side and part (b) is a plan view of the current collector 1 as seen from the top. The current collector 1 includes an Al foil 11, a Cu foil 12, and an adhesive layer 13.

The Al foil (aluminum foil) 11 is made of aluminum. The Al foil 11 is provided on one surface of the current collector 1. The Cu foil (copper foil) 12 is made of copper. The Cu foil 12 is provided on the other surface of the current collector 1 opposite to the one surface. The Cu foil 12 is joined to the Al foil 11 via the adhesive layer 13.

The adhesive layer 13 is made of, for example, a conductive adhesive containing an adhesive and a conductive component. The component of the adhesive is not particularly limited, but may be a curable resin such as an olefin resin or an acrylic resin. The conductive component is not particularly limited as long as the conductivity thereof is higher than that of the adhesive. Examples of the conductive component include metal particles, alloy particles such as aluminum-magnesium alloy particles, metal oxide particles or metal particles coated with precious metals, non-conductive particles coated with precious metals, non-conductive particles plated with metal, and carbon particles.

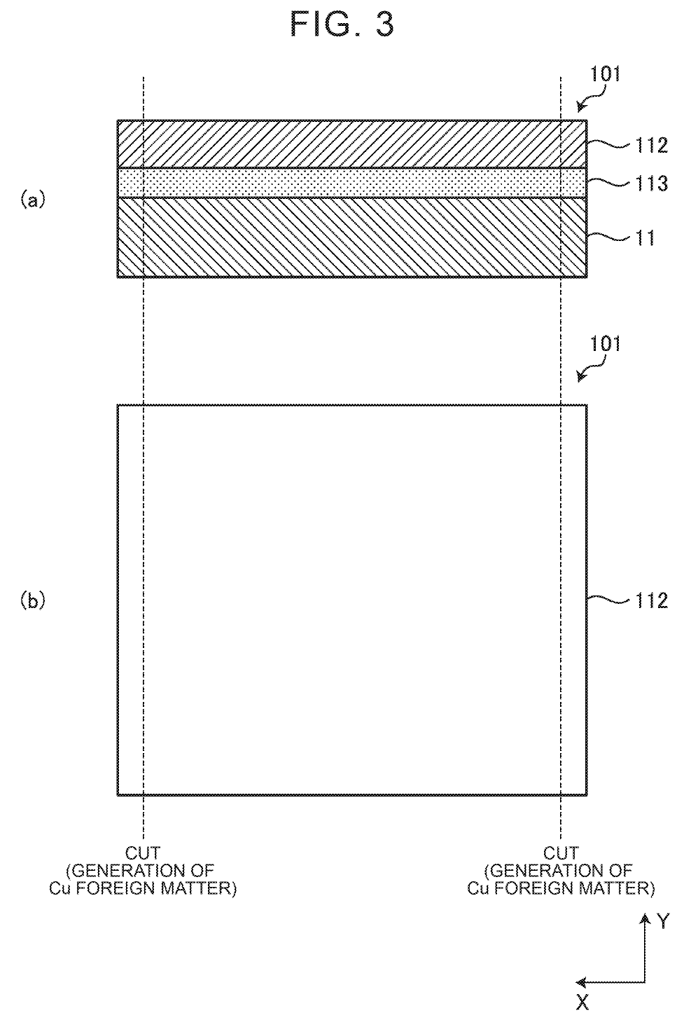

FIG. 3 is a diagram showing the configuration of a related-art current collector 101, in which part (a) is a sectional view of the current collector 101 as seen from the side and part (b) is a plan view of the current collector 101 as seen from the top. The current collector 101 includes the Al foil 11, a Cu foil 112, and an adhesive layer 113.

In the current collector 101, as shown in part (a) of FIG. 3, the Al foil 11 and the Cu foil 112 have equal areas. Therefore, when the right and left ends of the Al foil 11 and the Cu foil 112 are cut to obtain a specified size after the foils are formed, Cu foreign matter may adhere to the Al foil 11, which may cause self-discharge failure.

In the current collector 1 according to the embodiment, as shown in part (a) of FIG. 1, the area of the Cu foil 12 is smaller than the area of the Al foil 11. That is, when the area of the Al foil 11 is S1 and the area of the Cu foil 12 is S2, the relationship between the area S1 and the area S2 is "S1 > S2." Thus, the Al foil 11 protrudes from the ends of the Cu foil 12.

The shape and area of the Cu foil 12 shown in FIG. 1 are merely an example. The Cu foil 12 may have any configuration as long as the positions of both ends in an X-direction are inward of cutting positions (see the dashed lines). The Al foil 11 has a configuration in which the positions of both ends in the X-direction protrude outward beyond both the ends of the Cu foil 12 and are outward of the cutting positions (see the dashed lines).

In the current collector 1 shown in FIG. 1, the adhesive layer 13 has the same shape and area as the Cu foil 12. That is, the area of the adhesive layer 13 is smaller than the area of the Al foil 11. Therefore, the Al foil 11 protrudes also from the ends of the adhesive layer 13.

A protruding portion 111 of the Al foil 11 that protrudes from the end of the Cu foil 12 may be covered with, for example, a sealing member 14 as shown in FIG. 2. The sealing member 14 covers, for example, the entire protruding portion 111 (top, side, and bottom surfaces) and also the side surface of the adhesive layer 13. In consideration of covering with the sealing member 14, the amount of protrusion of the protruding portion 111 from the end of the Cu foil 12 is at least preferably 20 mm or less, and more preferably 10 mm or less.

The component of the sealing member 14 is not particularly limited, but may be a thermoplastic resin such as acid-modified polyethylene, acid-modified polypropylene, polyethylene, or polypropylene. By covering the protruding portion 111 with the sealing member 14 in this way, it is possible to suppress the Li alloying reaction of the Al foil 11 caused by charging and discharging. By covering the side surface of the adhesive layer 13 with the sealing member 14, it is possible to suppress the release of moisture from the adhesive layer 13, for example, when the adhesive layer 13 contains a water-based adhesive.

In the current collector for the bipolar electrode according to the embodiment described above, when cutting the current collector 1 to the specified size, only the Al foil 11 protruding from the end of the Cu foil 12 can be cut without cutting the Cu foil 12. Thus, it is possible to suppress the generation of the Cu foreign matter.

In the current collector for the bipolar electrode according to the embodiment, the Al foil 11 protruding from the end of the Cu foil 12 is covered with the sealing member 14, thereby suppressing the Li alloying reaction of the Al foil 11 caused by charging and discharging. In the current collector for the bipolar electrode according to the embodiment, the amount of use of the Cu foil 12 that is more expensive than the Al foil 11 can be reduced, and the only scrap material remaining during the cutting is the Al foil 11. Thus, recyclability is improved.

Further effects and modifications can easily be derived by persons skilled in the art. Therefore, broader aspects of the present disclosure are not limited to the specific details and the representative embodiment shown and described above. Accordingly, various modifications may be made without departing from the spirit or scope of the general concept of the disclosure as defined by the appended claims and their equivalents.

What is claimed is:

1. A current collector for a bipolar electrode, the current collector comprising:
an Al foil provided on one surface; and
a Cu foil provided on the other surface and joined to the Al foil, wherein
a relationship between an area S1 of the Al foil and an area S2 of the Cu foil is S1 > S2, and
the Al foil protrudes from an end of the Cu foil.

2. The current collector for the bipolar electrode according to claim 1, wherein a protruding portion of the Al foil that protrudes from the end of the Cu foil is covered with a sealing member.
